(19) United States
(12) Patent Application Publication
(10) Pub. No.: US 2025/0337331 A1
(43) Pub. Date: Oct. 30, 2025

(54) ISOLATED SWITCHING CONVERTER WITH IMPROVED TRANSIENT RESPONSE AND CONTROL CIRCUIT THEREOF

(71) Applicant: Chengdu Monolithic Power Systems Co., Ltd., Chengdu (CN)

(72) Inventors: Xiangyi Yang, Chengdu (CN); Li Wang, Chengdu (CN); Qiang Fan, Chengdu (CN); Panyin Liu, Chengdu (CN); Wei Mao, Chengdu (CN)

(21) Appl. No.: 19/189,243

(22) Filed: Apr. 24, 2025

(30) Foreign Application Priority Data
Apr. 28, 2024 (CN) 202410527741.9

(51) Int. Cl. H02M 3/335

(52) U.S. Cl. CPC H02M 3/33523

(57) ABSTRACT

A control circuit for an isolated switching converter. The control circuit includes a secondary control circuit and a primary control circuit. The secondary control circuit detects whether a load rise has occurred based on an output voltage and pulls down a voltage at a secondary winding of the switching converter in response to the detected load rise. The primary control circuit monitors a voltage across an auxiliary winding of the switching converter, generates a wakeup detecting signal based on the voltage across the auxiliary winding, and generates a primary switch control signal to control a primary switch based on the wakeup detecting signal.

This application claims the benefit of CN application 202410527741.9, filed on Apr. 28, 2024, and incorporated herein by reference.

### TECHNICAL FIELD OF THE INVENTION

The present invention generally relates to electronic circuits, and more particularly but not exclusively, to isolated switching converters and associated control circuits.

### BACKGROUND OF THE INVENTION

FIG. 1 illustrates an isolated switching converter 50 with primary side control. The isolated switching converter 50 detects an output voltage Vout by detecting a voltage at an auxiliary winding and controls the turning on and turning off of a primary switch MP based on the output voltage Vout. However, the voltage at the auxiliary winding can reflect the output voltage Vout only when the rectifier diode Da is conducted. In a light-load or no-load condition, the isolated switching converter 50 usually operates at a low switching frequency, the rectifier diode Da may be off for a long time, causing the switching converter 50 cannot obtain the output voltage Vout timely. If a load transient occurs during the non-conductive period of the rectifier diode Da, the switching converter 50 cannot respond in time, resulting in large undershoot in the output voltage Vout.

### SUMMARY OF THE INVENTION

An embodiment of the present invention discloses a control circuit for an isolated switching converter. The control circuit includes a first pin, a wakeup detecting circuit, an error amplifying circuit, a pull-up circuit and a primary switch control circuit. The first pin is configured to be coupled to an auxiliary winding of a transformer to receive an auxiliary sampling signal indicative of a voltage across the auxiliary winding. The wakeup detecting circuit is coupled to the first pin and configured to generate a wakeup detecting signal based on the auxiliary sampling signal. The error amplifying circuit is configured to generate an error amplifying signal based on a difference between a reference voltage signal and a feedback voltage signal indicative of an output voltage. The pull-up circuit is configured to, in response to the wakeup detecting signal being valid, pull up the error amplifying signal when the error amplifying signal is lower than a first reference value. The primary switch control circuit is configured to generate a primary switch control signal to control a primary switch based on the wakeup detecting signal and the error amplifying signal.

An embodiment of the present invention discloses an isolated switching converter including a transformer, a primary switch, a wakeup detecting circuit, an error amplifying circuit, a pull-up circuit and a primary switch control circuit. The transformer has a primary winding and an auxiliary winding. The primary switch is coupled to the primary winding. The wakeup detecting circuit is configured to receive an auxiliary sampling signal indicative of a voltage across the auxiliary winding and to generate a wakeup detecting signal based on the auxiliary sampling signal. The error amplifying circuit is configured to generate an error amplifying signal based on a difference between a reference voltage signal and a feedback voltage signal indicative of an output voltage. The primary switch control circuit is configured to generate a primary switch control signal to control the primary switch based on the wakeup detecting signal and the error amplifying signal. where after a duration when the auxiliary sampling signal remains below a wakeup voltage threshold reaches a wakeup duration threshold, if the auxiliary sampling signal becomes higher than the wakeup voltage threshold, the wakeup detecting signal is valid.

An embodiment of the present invention discloses a control circuit for an isolated switching converter, the control circuit includes a secondary control circuit and a primary control circuit. The secondary control circuit includes a first pin, a second pin, a load rise detecting circuit and a wakeup processing circuit. The first pin is configured to be coupled to a secondary winding of a transformer. The second pin is configured to receive an output voltage. The load rise detecting circuit is coupled to the second pin and configured to detect whether a load rise has occurred based on the output voltage. The wakeup processing circuit is coupled to the first pin, where in response to the detected load rise, the wakeup processing circuit is configured to pull down a voltage at the first pin. The primary control circuit includes a third pin, a wakeup detecting circuit and a primary switch control circuit. The third pin is configured to be coupled to an auxiliary winding of the transformer to receive an auxiliary sampling signal indicative of a voltage across the auxiliary winding. The wakeup detecting circuit is coupled to the third pin and configured to generate a wakeup detecting signal based on the auxiliary sampling signal. The primary switch control circuit is configured to generate a primary switch control signal to control a primary switch based on the wakeup detecting signal.

### BRIEF DESCRIPTION OF DRAWINGS

The present invention can be further understood with reference to the following detailed description and the appended drawings, wherein like elements are provided with like reference numerals.

FIG. 1 illustrates an isolated switching converter 50 with primary side control.

FIG. 2 illustrates a block diagram of an isolated switching converter 100 in accordance with an embodiment of the present invention.

FIG. 3 illustrates working waveforms of the isolated switching converter 100 in accordance with an embodiment of the present invention and working waveforms of prior art isolated switching converter.

FIG. 4 illustrates a circuit schematic of a secondary control circuit 10A used in the isolated switching converter 100 in accordance with an embodiment of the present invention.

FIG. 5 illustrates a circuit schematic of a secondary control circuit 10B used in the isolated switching converter 100 in accordance with another embodiment of the present invention.

FIG. 6 illustrates a circuit schematic of a primary control circuit 11A used in the isolated switching converter 100 in accordance with an embodiment of the present invention.

FIG. 7 illustrates working waveforms of the wakeup detecting circuit 111 shown in FIG. 6 in accordance with an embodiment of the present invention.

FIG. 8 illustrates a circuit schematic of a primary control circuit 11B used in the isolated switching converter 100 in accordance with another embodiment of the present invention.

FIG. 9 illustrates relationship between the peak current threshold IPKL and the error amplifying signal Vea and relationship between the switching frequency Freq and the error amplifying signal Vea.

FIG. 10 illustrates working waveforms of the primary control circuit 11B shown in FIG. 8 in accordance with an embodiment of the present invention.

FIG. 11 illustrates a working flowchart of a control method 1100 used in an isolated switching converter in accordance with an embodiment of the present invention.

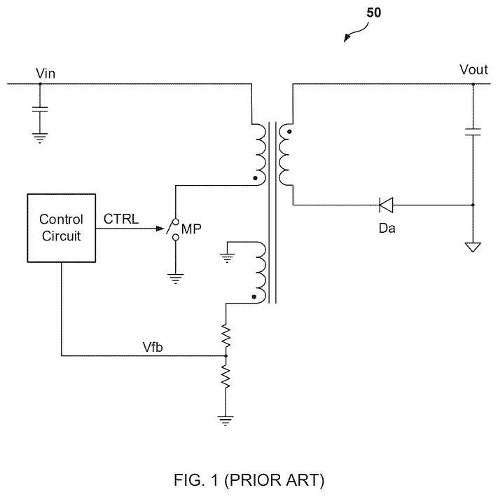

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

In the following embodiments, for simplicity, flyback converter is used as an example for illustration. However, the present invention can be applied to other suitable isolated switching converters.

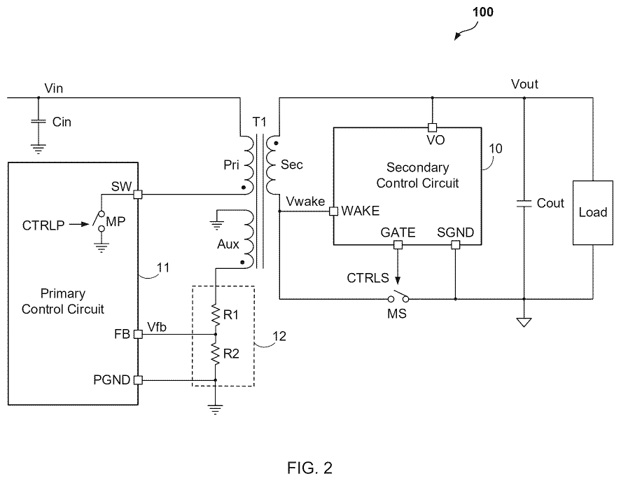

FIG. 2 illustrates a block diagram of an isolated switching converter 100 in accordance with an embodiment of the present invention. As shown in FIG. 2, the isolated switching converter 100 includes an input capacitor Cin, a transformer T1, a primary switch MP, a secondary switch MS, an output capacitor Cout, a secondary control circuit 10 and a primary control circuit 11. The transformer T1 has a primary winding Pri, a secondary winding Sec and an auxiliary winding Aux, where both the primary winding Pri and the secondary winding Sec have a first terminal and a second terminal. The first terminal of the primary winding Pri is coupled to the input capacitor Cin. The primary switch MP is coupled between the second terminal of the primary winding Pri and a primary reference ground. The first terminal of the secondary winding Sec is coupled to the output capacitor Cout. The secondary switch MS is coupled between the second terminal of the secondary winding Sec and a secondary reference ground. In the example shown in FIG. 2, the primary switch MP is internal to the primary control circuit 11. Those skilled in the art can understand that, in other embodiments, the primary switch MP may be external to the primary control circuit 11.

The primary control circuit 11 is configured to generate a primary switch control signal CTRLP to control the primary switch MP. The secondary control circuit 10 is configured to generate a secondary switch control signal CTRLS to control the secondary switch MS. The switching converter 100 is configured to convert an input voltage Vin into an output voltage Vout to power a load by turning on and turning off of the primary switch MP and the secondary switch MS.

The secondary control circuit 10 has a plurality of pins, including an output detecting pin VO, a wakeup pin WAKE, a driving pin GATE and a secondary ground pin SGND. The output detecting pin VO is coupled to the output voltage Vout. The wakeup pin WAKE is coupled to the second terminal of the secondary winding Sec. The driving pin GATE provides the secondary switch control signal CTRLS to the secondary switch MS. The secondary ground pin SGND is coupled to the secondary reference ground.

The primary control circuit 11 has a plurality of pins, including a feedback pin FB, a switching pin SW and a primary ground pin PGND. The feedback pin FB is coupled to the auxiliary winding Aux to receive an auxiliary sampling signal Vfb indicative of a voltage across the auxiliary winding Aux. The switching pin SW is coupled to the second terminal of the primary winding Pri. The primary ground pin PGND is coupled to the primary reference ground. In the example shown in FIG. 2, the switching converter 100 further includes a voltage dividing circuit 12 coupled to the auxiliary winding Aux for generating the auxiliary sampling signal Vfb. In one embodiment, the voltage dividing circuit 12 includes resistors R1 and R2.

The secondary control circuit 10 receives the output voltage Vout through the output detecting pin VO, detects whether a load rise has occurred based on the output voltage Vout, and pulls down a voltage Vwake at the wakeup pin WAKE when the load rise is detected. Accordingly, the voltage across the auxiliary winding Aux will have a jitter and the auxiliary sampling signal Vfb will also have a jitter. The primary control circuit 11 determines whether the load rise on the secondary side has occurred based on the jitter amplitude of the auxiliary sampling signal Vfb. When the primary control circuit 11 determines that the load rise on the secondary side has occurred, the primary side is awakened and the primary switch MP is configured to be turned on. In one embodiment, pull down the voltage Vwake means that the secondary control circuit 10 lowers the voltage Vwake. In one embodiment, the secondary control circuit 10 pulls down the voltage Vwake to zero. In other embodiments, in order to limit the current flowing through the wakeup pin WAKE to avoid the second control circuit 10 being burnt, the pull-down capability of the secondary control circuit 10 is limited and the voltage Vwake may be higher than zero.

In one embodiment, when the jitter amplitude of the auxiliary sampling signal Vfb exceeds a wakeup voltage threshold Vthw, it represents that the load rise has occurred on the secondary side. In one embodiment, the load rise represents that a load current drawn by the load rises rapidly.

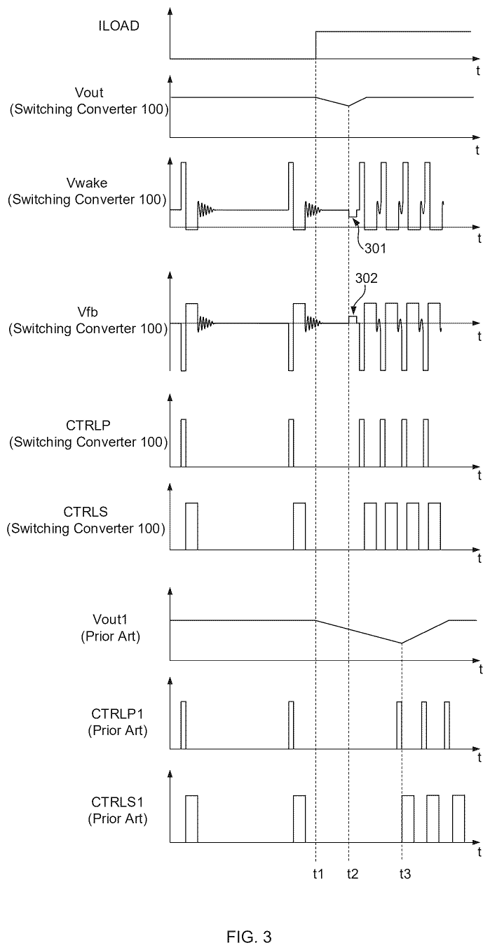

FIG. 3 illustrates working waveforms of the isolated switching converter 100 in accordance with an embodiment of the present invention and working waveforms of prior art isolated switching converter. FIG. 3 shows, from top to bottom, a load current ILOAD, the output voltage Vout, the voltage Vwake at the wakeup pin WAKE, the auxiliary sampling signal Vfb, the primary switch control signal CTRLP, the secondary switch control signal CTRLS of the switching converter 100, as well as an output voltage Vout1, a primary switch control signal CTRLP1 and a secondary switch control signal CTRLS1 of prior art switching converter with primary side control.

As shown in FIG. 3, before time t1, the load is light and the switching converter 100 operates at a low switching frequency.

At time t1, the load rise occurs, the load current ILOAD rises rapidly and the output voltage Vout starts to decrease.

At time t2, the secondary control circuit 10 detects that the load rise has occurred based on the output voltage Vout and pulls down the voltage Vwake at the wakeup pin WAKE (see FIG. 3, 301). In response to the voltage Vwake being pulled down, the auxiliary sampling signal Vfb has a jitter (see FIG. 3, 302). The jitter of the auxiliary sampling signal Vfb is detected by the primary control circuit 11 and the primary switch MP is turned on in response to the detected jitter. Then the switching converter 100 operates at a high switching frequency and the output voltage Vout restores to the expected value quickly.

In prior art switching converter, after the load rise occurs, the switching converter still operates at low switching frequency. The secondary switch is not turned on and the switching converter cannot detect and respond to the load rise, until time t3. At this time, the output voltage has already had a large undershoot.

According to the embodiments of the present invention, after the load rise occurs, the secondary side pulls down the voltage Vwake at the wakeup pin WAKE, the primary side can detect the load rise timely by monitoring the auxiliary sampling signal Vfb, thereby responding quickly. This can improve the transient response and reduce the undershoot in the output voltage Vout.

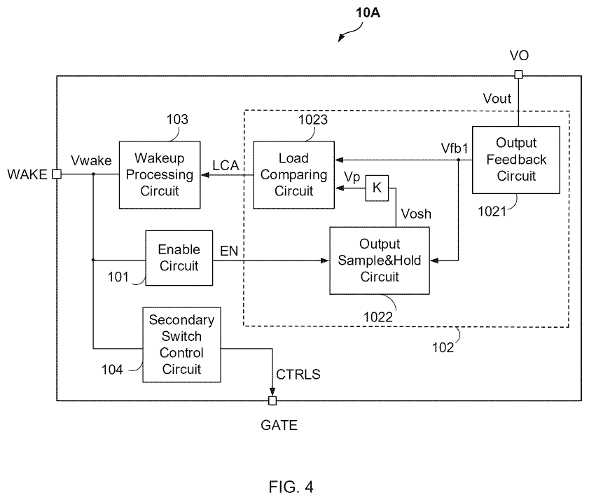

FIG. 4 illustrates a circuit schematic of a secondary control circuit 10A used in the isolated switching converter 100 in accordance with an embodiment of the present invention. As shown in FIG. 4, the secondary control circuit 10A includes an enable circuit 101, a load rise detecting circuit 102, a wakeup processing circuit 103 and a secondary switch control circuit 104.

The enable circuit 101 is coupled to the wakeup pin WAKE and generates an enable signal EN based on the voltage Vwake at the wakeup pin WAKE. In one embodiment, when the duration of the voltage Vwake being lower than an enable voltage threshold Vthe reaches an enable duration threshold Tthe, the enable signal EN is valid (e.g., high level) and the valid state is maintained for a duration TH.

The load rise detecting circuit 102 is coupled to the output detecting pin VO to receive the output voltage Vout and detects whether the load rise has occurred based on the output voltage Vout.

In the example shown in FIG. 4, the load rise detecting circuit 102 includes an output feedback circuit 1021, an output sample-and-hold circuit 1022 and a load comparing circuit 1023. The output feedback circuit 1021 is coupled to the output detecting pin VO to receive the output voltage Vout and generates a first feedback voltage signal Vfb1 indicative of the output voltage Vout based on the output voltage Vout. The output sample-and-hold circuit 1022 samples and holds the first feedback voltage signal Vfb1 to generate an output sample-and-hold signal Vosh. In one embodiment, the output sample-and-hold circuit 1022 is further coupled to the enable circuit 101 to receive the enable signal EN. When the enable signal EN is valid, the output sample-and-hold circuit 1022 is enabled to sample and hold the first feedback voltage signal Vfb1 to generate the output sample-and-hold signal Vosh. The load comparing circuit 1023 compares the first feedback voltage signal Vfb1 with a proportional voltage signal Vp indicative of the output sample-and-hold signal Vosh and generates a load comparing signal LCA. When the first feedback voltage signal Vfb1 is lower than the proportional voltage signal Vp, the load comparing signal LCA is valid (e.g., high level), indicating that the load rise has occurred. In one embodiment, the proportional voltage signal Vp is the product of the output sample-and-hold signal Vosh and a proportional coefficient K. In a further embodiment, the proportionality coefficient K is 97%.

The wakeup processing circuit 103 is coupled to the wakeup pin WAKE and also coupled to the load comparing circuit 1023 to receive the load comparing signal LCA. In response to the load comparing signal LCA being valid, indicating the load rise has occurred, the wakeup processing circuit 103 pulls down the voltage Vwake at the wakeup pin WAKE.

The secondary switch control circuit 104 is coupled to the wakeup pin WAKE and generates a secondary switch control signal CTRLS to control the secondary switch MS based on the voltage Vwake at the wakeup pin WAKE. In one embodiment, the secondary switch control circuit 104 controls the turning on of the secondary switch MS based on a decreasing slope of the voltage Vwake and controls the turning off of the secondary switch MS based on a comparison result between the voltage Vwake and a turn off threshold Voff.

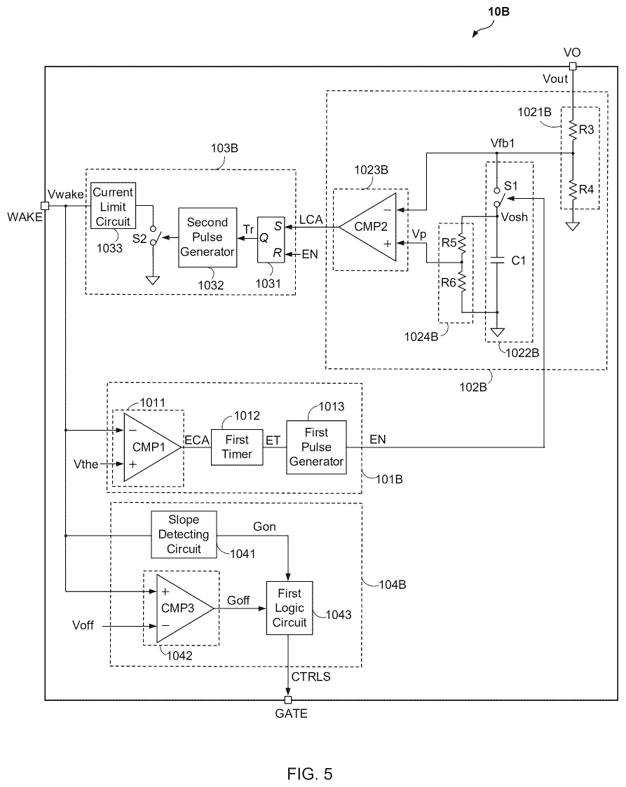

FIG. 5 illustrates a circuit schematic of a secondary control circuit 10B used in the isolated switching converter 100 in accordance with another embodiment of the present invention. As shown in FIG. 5, the secondary control circuit 10B includes an enable circuit 101B, a load rise detecting circuit 102B, a wakeup processing circuit 103B and a secondary switch control circuit 104B.

The enable circuit 101B includes an enable comparing circuit 1011, a first timer 1012 and a first pulse generator 1013. The enable comparing circuit 1011 compares the voltage Vwake at the wakeup pin WAKE with the enable voltage threshold Vthe to generate an enable comparing signal ECA. When the voltage Vwake is lower than the enable voltage threshold Vthe, the enable comparing signal ECA is valid (e.g., high level). In one embodiment, the enable comparing circuit 1011 includes a comparator CMP1.

The first timer 1012 times the valid duration of the enable comparing signal ECA and generates an enable timing signal ET. When the valid duration of the enable comparing signal ECA reaches the enable duration threshold Tthe, the enable timing signal ET becomes valid (e.g., high level). In response to the enable timing signal ET being valid, the first pulse generator 1013 generates the enable signal EN with the duration TH.

The load rise detecting circuit 102B includes an output feedback circuit 1021B, an output sample-and-hold circuit 1022B, a proportional voltage generator 1024B and a load comparing circuit 1023B. The output feedback circuit 1021B includes a voltage dividing circuit having resistors R3 and R4, which divides the output voltage Vout to generate the first feedback voltage signal Vfb1. In other embodiments, the output feedback circuit 1021B may include multiple voltage dividing circuits to obtain feedback voltage signals with different voltage division ratios.

The output sample-and-hold circuit 1022B includes a switch S1 and a capacitor C1 coupled between an output terminal of the output feedback circuit 1021B and the secondary reference ground. The output sample-and-hold circuit 1022B receives the enable signal EN. In response to the enable signal EN being valid, the switch S1 is turned on, and the output sample-and-hold circuit 1022B samples and holds the first feedback voltage signal Vfb1 to generate the output sample-and-hold signal Vosh across capacitor C1.

The proportional voltage generator 1024B includes a voltage dividing circuit having resistors R5 and R6, which divides the output sample-and-hold signal Vosh to generate a proportional voltage signal Vp. Where the voltage division ratio of the proportional voltage generator 1024B is the proportional coefficient K.

The load comparing circuit 1023B compares the first feedback voltage signal Vfb1 with the proportional voltage signal Vp to generate a load comparing signal LCA. When the first feedback voltage signal Vfb1 is lower than the proportional voltage signal Vp, the load comparing signal LCA is valid (e.g., high level). In one embodiment, the load comparing circuit 1023B includes a comparator CMP2.

The wakeup processing circuit 103B includes a RS flip-flop 1031, a second pulse generator 1032 and a pull-down switch S2. The RS flip-flop 1031 has a set terminal S, a reset terminal R and an output terminal Q. The set terminal S receives the load comparing signal LCA, the reset terminal R receives the enable signal EN and the output terminal Q provides a trigger signal Tr. The second pulse generator 1032, in response to the trigger signal Tr, generates a pulse with a duration Ts1 to turn on the pull-down switch S2 for the duration Ts1. In one embodiment, the duration Ts1 is 1 μs. In one embodiment, in response to the trigger signal Tr, the second pulse generator 1032 generates pulses with the duration Ts1 at regular interval until the primary side of the switching converter 100 is awakened. In a further embodiment, the interval duration is 30 μs. In the example shown in FIG. 5, the wakeup processing circuit 103B further includes a current limit circuit 1033, which limits the current flowing through the pull-down switch S2 when it is turned on, thereby preventing damage to the pull-down switch S2.

The secondary switch control circuit 104B includes a slope detecting circuit 1041, a turning off comparing circuit 1042 and a first logic circuit 1043. The slope detecting circuit 1041 detects the decreasing slope of the voltage Vwake at the wakeup pin WAKE and generates a turning on control signal Gon to control the turning on of the secondary switch MS. In one embodiment, when the decreasing slope of voltage Vwake is higher than a slope threshold, the turning on control signal Gon is valid (e.g., high level).

The turning off comparing circuit 1042 compares the voltage Vwake at the wakeup pin WAKE with the turning off threshold Voff and generates a turning off control signal Goff to control the turning off of the secondary switch MS. When the voltage Vwake is higher than the turning off threshold Voff, the turning off control signal Goff is valid (e.g., high level). In one embodiment, the turning off threshold Voff is about −3 mV. In one embodiment, the turning off comparing circuit 1042 includes a comparator CMP3.

The first logic circuit 1043 generates a secondary switch control signal CTRLS to control the secondary switch MS based on the turning on control signal Gon and the turning off control signal Goff.

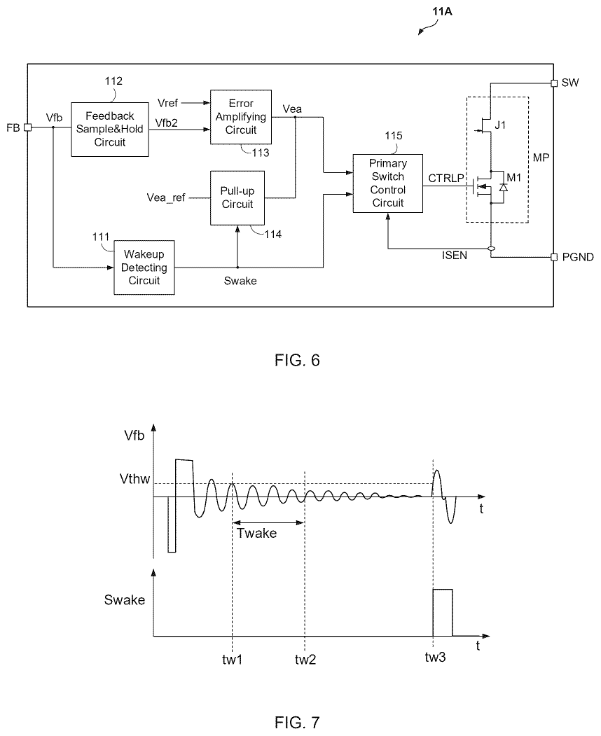

FIG. 6 illustrates a circuit schematic of a primary control circuit 11A used in the isolated switching converter 100 in accordance with an embodiment of the present invention. The primary control circuit 11A includes a wakeup detecting circuit 111, a feedback sample-and-hold circuit 112, an error amplifying circuit 113, a pull-up circuit 114 and a primary switch control circuit 115.

The wakeup detecting circuit 111 is coupled to the feedback pin FB to receive the auxiliary sampling signal Vfb and generates a wakeup detecting signal Swake based on the auxiliary sampling signal Vfb. Where after the duration when the auxiliary sampling signal Vfb remains below the wakeup voltage threshold Vthw reaches a wakeup duration threshold Twake, if it is detected that the auxiliary sampling signal Vfb becomes higher than the wakeup voltage threshold Vthw, the wakeup detecting signal Swake is valid (e.g., high level), indicating that the load rise has occurred on the secondary side.

FIG. 7 illustrates working waveforms of the wakeup detecting circuit 111 shown in FIG. 6 in accordance with an embodiment of the present invention. In the light-load or no-load condition, the switching converter 100 operates at low switching frequency. After the primary switch MP and the secondary switch MS are both turned off, the auxiliary sampling signal Vfb will have a resonant ringing. At time tw1, the resonant amplitude starts to be lower than the wakeup threshold Vthw. At time tw2, the duration when the auxiliary sampling signal Vfb remains below the wakeup threshold Vthw reaches the wakeup duration threshold Twake. Afterwards, in response to the load rise, the secondary control circuit 10 (as shown in FIG. 2) pulls down the voltage Vwake at the wakeup pin WAKE. Accordingly, the auxiliary sampling signal Vfb has a jitter. The jitter is detected by the wakeup detecting circuit 111 (e.g., the auxiliary sampling signal Vfb becomes higher than the wakeup threshold Vthw) at time tw3. The wakeup detecting signal S wake is switched from the invalid state (e.g., low level) to the valid state (e.g., high level). By setting suitable wakeup duration threshold Twake, the wakeup detecting circuit 111 can distinguish the jitter of the auxiliary sampling signal Vfb due to the load rise from the resonant ringing of the auxiliary sampling signal Vfb after the primary switch MP and the secondary switch MS are both turned off and generate the wakeup detecting signal S wake indicative of the load rise accurately.

Continue referring to FIG. 6, the feedback sample-and-hold circuit 112 is coupled to the feedback pin FB to receive the auxiliary sampling signal Vfb and generates a second feedback voltage signal Vfb2 indicative of the output voltage Vout based on the auxiliary sampling signal Vfb. In one embodiment, the feedback sample-and-hold circuit 112 samples and holds the auxiliary sampling signal Vfb to generate the second feedback voltage signal Vfb2 when the primary switch MP is turned off and the secondary switch MS is turned on.

The error amplifying circuit 113 has a first input terminal, a second input terminal and an output terminal, where the first input terminal receives a reference voltage signal Vref and the second input terminal receives the second feedback voltage signal Vfb2. Based on the difference between the reference voltage signal Vref and the second feedback voltage signal Vfb2, the error amplifying circuit 113 generates an error amplifying signal Vea at the output terminal.

The pull-up circuit 114 has a first terminal, a second terminal and a control terminal, where the first terminal receives the first reference value Vea_ref, the second terminal is coupled to the output terminal of the error amplifying circuit 113 and the control terminal receives the wakeup detecting signal Swake. When the wakeup detecting signal Swake is valid, the pull-up circuit 114 determines whether to pull up the error amplifying signal Vea based on the error amplifying signal Vea and the first reference value Vea_ref. In one embodiment, pull up the error amplifying signal Vea means that the pull-up circuit 114 increases the value of the error amplifying signal Vea. In one embodiment, if the error amplifying signal Vea is lower than the first reference value Vea_ref, the pull-up circuit 114 pulls up the value of the error amplifying signal Vea to the first reference value Vea_ref; if the error amplifying signal Vea is higher than the first reference value Vea_ref, the pull-up circuit 114 does not change the value of the error amplifying signal Vea.

The primary switch control circuit 115 receives the wakeup detecting signal Swake and the error amplifying signal Vea and generates the primary switch control signal CTRLP to control the primary switch MP based on the wakeup detecting signal Swake and the error amplifying signal Vea. In one embodiment, in response to the wakeup detecting signal Swake being valid, the primary switch MP is configured to be turned on.

In the example shown in FIG. 6, the primary switch control circuit 115 further receives a current sampling signal ISEN indicative of a current flowing through the primary switch MP and generates the primary switch control signal CTRLP based on the wakeup detecting signal Swake, the error amplifying signal Vea and the current sampling signal ISEN. In one embodiment, when the current sampling signal ISEN increases to a peak current threshold IPKL, the primary switch MP is configured to be turned off.

In the example shown in FIG. 6, the primary switch MP is illustrated as a cascaded structure including a normally on switch device J1 and a normally off switch device M1. The normally on switch device J1 has a first terminal and a second terminal, where the first terminal is coupled to the switching pin SW. The normally off switch device M1 has a first terminal, a second terminal and a control terminal, where the first terminal is coupled to the second terminal of the normally on switch device J1, the second terminal is coupled to the primary ground pin PGND and the control terminal receives the primary switch control signal CTRLP. In other embodiments, the primary switching MP can also include other suitable controllable semiconductor devices, such as BJT, JFET, MOSFET, IGBT, and so on.

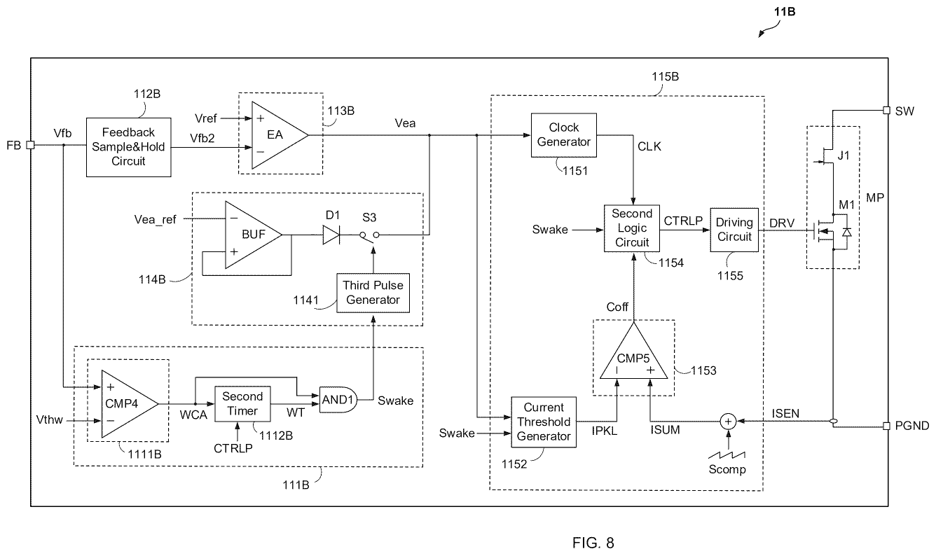

FIG. 8 illustrates a circuit schematic of a primary control circuit 11B used in the isolated switching converter 100 in accordance with another embodiment of the present invention. The primary control circuit 11B includes a wakeup detecting circuit 111B, a feedback sample-and-hold circuit 112B, an error amplifying circuit 113B, a pull-up circuit 114B and a primary switch control circuit 115B.

The wakeup detecting circuit 111B includes a wakeup comparing circuit 1111B, a second timer 1112B and an AND gate AND1. The wakeup comparing circuit 1111B compares the auxiliary sampling signal Vfb with the wakeup voltage threshold Vthw to generate a wakeup comparing signal WCA. When the auxiliary sampling signal Vfb is higher than the wakeup voltage threshold Vthw, the wakeup comparing signal WCA is valid (e.g., high level). In one embodiment, the wakeup comparing circuit 1111B includes a comparator CMP4.

The second timer 1112B generates a wakeup timing signal WT based on the primary switch control signal CTRLP and the wakeup comparing signal WCA. After the primary switch MP is turned off, the second timer 1112B times the invalid duration of the wakeup comparing signal WCA and generates the wakeup timing signal WT. During the timing process, if the wakeup comparing signal WCA is valid, i.e. the auxiliary sampling signal Vfb is higher than the wakeup voltage threshold Vthw, the timing duration of the second timer 1112B is reset to zero. When the timing duration reaches the wakeup duration threshold Twake, the wakeup timing signal WT is valid (e.g., high level).

The AND gate AND1 performs a logical AND operation on the wakeup comparing signal WCA and the wakeup timing signal WT to generate the wakeup detecting signal Swake.

The feedback sample-and-hold circuit 112B is coupled to the feedback pin FB to receive the auxiliary sampling signal Vfb and generates a second feedback voltage signal Vfb2 based on the auxiliary sampling signal Vfb.

The error amplifying circuit 113B includes an error amplifier EA. The error amplifier EA has a non-inverting input terminal, an inverting input terminal and an output terminal, where the non-inverting input terminal receives a reference voltage signal Vref and the inverting input terminal receives the second feedback voltage signal Vfb2. The error amplifier EA provides an error amplifying signal Vea at the output terminal based on the difference between the reference voltage signal Vref and the second feedback voltage signal Vfb2.

The pull-up circuit 114B includes a buffer BUF, a unidirectional conduction circuit D1 and a switch S3. The buffer BUF has an input terminal and an output terminal, where the input terminal receives a first reference value Vea_ref. The unidirectional conduction circuit D1 has an input terminal and an output terminal, where the input terminal is coupled to the output terminal of the buffer BUF to receive the first reference value Vea_ref. The switch S3 has a first terminal, a second terminal and a control terminal, where the first terminal is coupled to the output terminal of the unidirectional conduction circuit D1 and the second terminal is coupled to the output terminal of the error amplifying circuit 113B. In response to the wakeup detecting signal S wake being valid, the switch S3 is turned on. At this time, if the first reference value Vea_ref is higher than the error amplifying signal Vea, the unidirectional conduction circuit D1 conducts, and the value of the error amplifying signal Vea is pulled up to the first reference value Vea_ref; if the first reference value Vea_ref is lower than the error amplifying signal Vea, the unidirectional conduction circuit D1 is off, and the value of the error amplifying signal Vea is not affected by the first reference value Vea ref and remains unchanged. In one embodiment, the unidirectional conduction circuit D1 includes a diode.

In one embodiment, the pull-up circuit 114B further includes a third pulse generator 1141. In response to the wakeup detecting signal S wake being valid, the third pulse generator 1141 generates a pulse with a duration Ts2 to turn on the switch S3 for the duration Ts2. In one embodiment, the duration Ts2 is 10 μs.

The primary switch control circuit 115B includes a clock generator 1151, a current threshold generator 1152, a current comparing circuit 1153, a second logic circuit 1154 and a driving circuit 1155.

The clock generator 1151 receives the error amplifying signal Vea and generates a clock signal CLK to control the switching frequency of the primary switch MP (i.e., the switching frequency Freq of the switching converter 100) based on the error amplifying signal Vea. The frequency of the clock signal CLK is related to the error amplifying signal Vea, that is, the switching frequency Freq of the switching converter 100 is related to the error amplifying signal Vea.

The current threshold generator 1152 receives the error amplifying signal Vea and generates a peak current threshold IPKL to control the peak value of the current flowing through the primary switch MP based on the error amplifying signal Vea. In the example shown in FIG. 8, the peak current threshold IPKL has an upper limit value IPKM. The current threshold generator 1152 further receives the wakeup detecting signal Swake. In response to the wakeup detecting signal Swake being valid, the current threshold generator 1152 sets the peak current threshold IPKL to the upper limit value IPKM, thereby increasing the peak value of the current flowing through the primary switch MP to increase the energy transmitted to the output terminal of the switching converter 100 and rapidly reduce the undershoot in the output voltage Vout.

The current comparing circuit 1153 compares the current sampling signal ISEN indicative of the current flowing through the primary switch MP with the peak current threshold IPKL and generates a turning off control signal Coff to control the turning off of the primary switch MP. In one embodiment, when the current sampling signal ISEN increases to the peak current threshold IPKL, the turning off control signal Coff is valid and the primary switch MP is turned off. In a further embodiment, the current comparing circuit 1153 compares a superimposed signal ISUM of the current sampling signal ISEN and a compensation signal Scomp with the peak current threshold IPKL to generate the turning off control signal Coff. In one embodiment, the compensation signal Scomp is a triangular wave signal.

The second logic circuit 1154 generates the primary switch control signal CTRLP based on the clock signal CLK, the wakeup detecting signal S wake and the turning off control signal Coff. In one embodiment, in response to the wakeup detecting signal Shake being valid, the primary switch control signal CTRLP is valid and the primary switch MP is turned on; in response to the turning off control signal Coff being valid, the primary switch control signal CTRLP is invalid and the primary switch MP is turned off. The switching frequency of the primary switch MP relates to the clock signal CLK.

The driving circuit 1155 generates a driving signal DRV to drive the primary switch MP based on the primary switch control signal CTRLP.

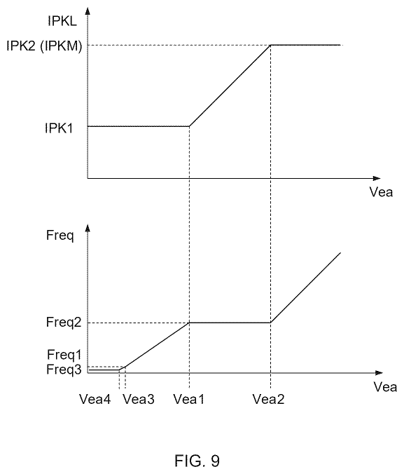

FIG. 9 illustrates relationship between the peak current threshold IPKL and the error amplifying signal Vea and relationship between the switching frequency Freq and the error amplifying signal Vea. As shown in FIG. 9, when the error amplifying signal Vea is lower than a first error amplifying threshold Vea1, the peak current threshold IPKL keeps at a first current threshold IPK1. When the error amplifying signal Vea is between the first error amplifying threshold Vea1 and a second error amplifying threshold Vea2, as the error amplifying signal Vea increases, the peak current threshold IPKL increases from the first current threshold IPK1 to a second current threshold IPK2, where the second error amplifying threshold Vea2 is higher than the first error amplifying threshold Vea1. When the error amplifying signal Vea is higher than the second error amplifying threshold Vea2, the peak current threshold IPKL keeps at the second current threshold IPK2. In the example shown in FIG. 9, the second current threshold IPK2 and the upper limit value IPKM are the same.

When the error amplifying signal Vea is between a third error amplifying threshold Vea3 and the first error amplifying threshold Vea1, as the error amplifying signal Vea increases, the switching frequency Freq increases from a first frequency Freq1 to a second frequency Freq2, where the third error amplifying threshold Vea3 is lower than the first error amplifying threshold Vea1. When the error amplifying signal Vea is between the first error amplifying threshold Vea1 and the second error amplifying threshold Vea2, the switching frequency Freq keeps at the second frequency Freq2. When the error amplifying signal Vea is higher than the second error amplifying threshold Vea2, the switching frequency Freq increases with the increase of the error amplifying signal Vea. Furthermore, in the example shown in FIG. 9, when the error amplifying signal Vea is lower than a fourth error amplifying threshold Vea4, the switching frequency Freq keeps at a third frequency Freq3. When the error amplifying signal Vea is between the fourth error amplifying threshold Vea4 and the third error amplifying threshold Vea3, as the error amplifying signal Vea increases, the switching frequency Freq increases from the third frequency Freq3 to the first frequency Freq1, where the fourth error amplifying threshold Vea4 is lower than the third error amplifying threshold Vea3.

According to the embodiments of the present invention, the wakeup detecting circuit 111B detects the load rise based on the auxiliary sampling signal Vfb and sets the wakeup detecting signal Swake to valid state in response to the detected load rise. In response to the wakeup detecting signal S wake being valid, the pull-up circuit 114B pulls up the error amplifying signal Vea. In response to the increasing error amplifying signal Vea, the frequency of the clock signal CLK and/or the peak current threshold IPKL increase, the switching frequency Freq and/or the peak of the current flowing through the primary switch MP increase, thereby increasing the energy transmitted to the output terminal of the switching converter 100 and reducing the undershoot in the output voltage Vout.

Those skilled in the art can understand that, in other embodiments, the relationship between the peak current threshold IPKL and the error amplifying signal Vea and the relationship between the switching frequency Freq and the error amplifying signal Vea can be different from the example shown in FIG. 9, as long as can increase the energy transmitted to the output terminal of the switching converter 100.

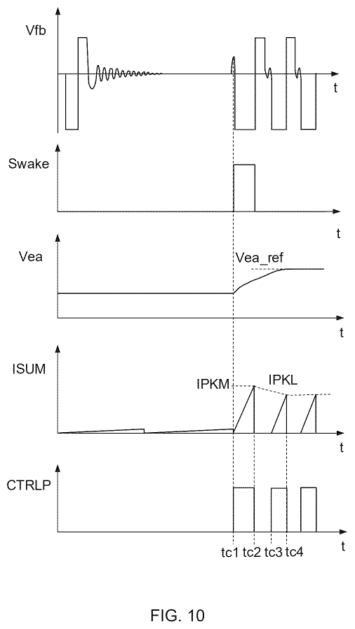

FIG. 10 illustrates working waveforms of the primary control circuit 11B shown in FIG. 8 in accordance with an embodiment of the present invention. FIG. 10 shows, from top to bottom, the auxiliary sampling signal Vfb, the wakeup detecting signal Swake, the error amplifying signal Vea, the superimposed signal ISUM and the primary switch control signal CTRLP.

At time tc1, the jitter of the auxiliary sampling signal Vfb is detected and the wakeup detecting signal Swake is switched from invalid (e.g., low level) to valid (e.g., high level). In response to the wakeup detecting signal S wake being valid, the pull-up circuit 114B pulls up the error amplifying signal Vea, the primary switch control circuit 115B turns on the primary switch MP, and the current threshold generator 1152 sets the peak current threshold IPKL to the upper limit value IPKM.

After the primary switch MP is turned on, the current flowing through the primary switch MP increases and the superimposed signal ISUM increases accordingly.

At time tc2, the superimposed signal ISUM increases to the peak current threshold IPKL (at this time, the peak current threshold IPKL is equal to the upper limit value IPKM), the primary switch control circuit 115B turns off the primary switch MP. After the wakeup detecting signal Swake is valid, the peak current threshold IPKL is set to the upper limit value IPKM in the first switching cycle of the primary switching MP, which can increase the energy transmitted to the output terminal of the switching converter 100 and reduce the undershoot in the output voltage Vout quickly and effectively.

After time tc2, the peak current threshold IPKL and switching frequency Freq are determined by the error amplifying signal Vea.

At time tc3, the primary switch control signal CTRLP is valid, and the primary switch MP is turned on.

At time tc4, the superimposed signal ISUM increases to the peak current threshold IPKL again, and the primary switch MP is turned off.

After several switching cycles, the switching converter 100 enters steady state. In one embodiment, the steady state refers to the operating state of the switching converter 100 when the load is steady.

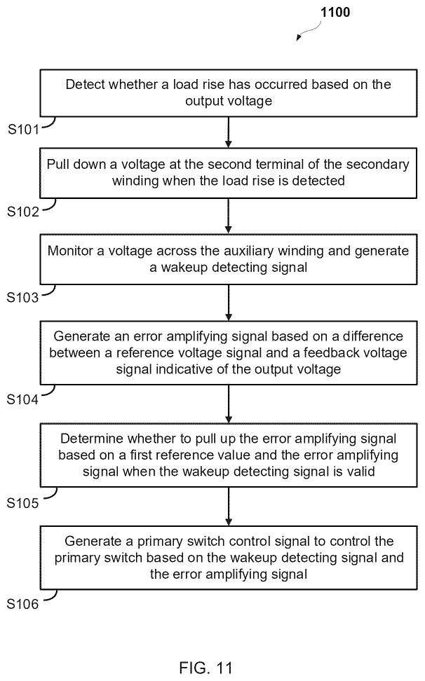

FIG. 11 illustrates a working flowchart of a control method 1100 used in an isolated switching converter in accordance with an embodiment of the present invention. The isolated switching converter includes a primary switch, a secondary switch and a transformer having a primary winding, a secondary winding and an auxiliary winding. The primary switch is coupled to the primary winding. The secondary winding has a first terminal and a second terminal, where the first terminal is configured to provide an output voltage to a load and the second terminal is coupled to the secondary switch. The control method 1100 includes steps S101˜S106.

At step S101, whether a load rise has occurred is detected based on the output voltage.

At step S102, a voltage at the second terminal of the secondary winding is pulled down when the load rise is detected.

At step S103, a wakeup detecting signal is generated by monitoring a voltage across the auxiliary winding. In one embodiment, after the duration when an auxiliary sampling signal indicative of the voltage across the auxiliary winding remains below a wakeup voltage threshold reaches a wakeup duration threshold, if it is detected that the auxiliary sampling signal becomes higher than the wakeup voltage threshold, the wakeup detecting signal is valid.

At step S104, an error amplifying signal is generated based on a difference between a reference voltage signal and a feedback voltage signal indicative of the output voltage. In one embodiment, the feedback voltage signal is generated by sampling and holding the voltage across the auxiliary winding.

At step S105, whether to pull up the error amplifying signal is determined based on a first reference value and the error amplifying signal when the wakeup detecting signal is valid. In one embodiment, if the error amplifying signal is lower than the first reference value, the value of the error amplifying signal is pulled up to the first reference value; if the error amplifying signal is higher than the first reference value, keep the value of the error amplifying signal unchanged.

At step 106, a primary switch control signal is generated to control the primary switch based on the error amplifying signal and the wakeup detecting signal. In one embodiment, when the wakeup detecting signal is valid, the primary switch is turned on.

In one embodiment, the control method 1100 further includes: a peak current threshold is generated based on the error amplifying signal and the wakeup detecting signal; a current sampling signal indicative of the current flowing through the primary switch is compared with the peak current threshold to generate a turning off control signal to control the turning off of the primary switch, where the peak current threshold is set to an upper limit value in response to the wakeup detecting signal being valid.

Those skilled in the art can understand that the high level/low level of control signal is related to the type of the power switch. For example, if the power switch is N-type MOSFET, when the control signal is high level, the power switch is turned on; when the control signal is low level, the power switch is turned off. If the power switch is P-type MOSFET, when the control signal is high level, the power switch is turned off; when the control signal is low level, the power switch is turned on. The high level/low level of the control signals shown in the above embodiments are used for illustrative purposes, not used for limiting the present invention.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A control circuit for an isolated switching converter, the control circuit comprising:
a first pin configured to be coupled to an auxiliary winding of a transformer to receive an auxiliary sampling signal indicative of a voltage across the auxiliary winding;
a wakeup detecting circuit coupled to the first pin and configured to generate a wakeup detecting signal based on the auxiliary sampling signal;
an error amplifying circuit configured to generate an error amplifying signal based on a difference between a reference voltage signal and a feedback voltage signal indicative of an output voltage;
a pull-up circuit configured to, in response to the wakeup detecting signal being valid, pull up the error amplifying signal when the error amplifying signal is lower than a first reference value; and
a primary switch control circuit configured to generate a primary switch control signal to control a primary switch based on the wakeup detecting signal and the error amplifying signal.

2. The control circuit of claim 1, wherein the primary switch control circuit is configured to turn on the primary switch in response to the wakeup detecting signal being valid.

3. The control circuit of claim 1, wherein the pull-up circuit comprises:
a unidirectional conduction circuit having an input terminal and an output terminal, wherein the input terminal is configured to receive the first reference value; and
a switch having a first terminal, a second terminal and a control terminal, wherein the first terminal is coupled to the output terminal of the unidirectional conduction circuit, the second terminal is coupled to an output terminal of the error amplifying circuit and the control terminal is configured to receive the wakeup detecting signal.

4. The control circuit of claim 3, wherein the pull-up circuit further comprises:
a buffer having an input terminal and an output terminal, wherein the input terminal is configured to receive the first reference value and the output terminal is coupled to the input terminal of the unidirectional conduction circuit.

5. The control circuit of claim 1, wherein the primary switch control circuit comprises:
a current threshold generator configured to generate a peak current threshold based on the error amplifying signal and the wakeup detecting signal; and
a current comparing circuit configured to generate a turning off control signal by comparing a current sampling signal indicative of a current flowing through the primary switch with the peak current threshold; wherein
in response to the wakeup detecting signal being valid, the peak current threshold is configured to be set to an upper limit value.

6. The control circuit of claim 5, wherein:
when the error amplifying signal is lower than a first error amplifying threshold, the peak current threshold keeps at a first current threshold unchanged;
when the error amplifying signal is between the first error amplifying threshold and a second error amplifying threshold, the peak current threshold increases as the error amplifying signal increases, wherein the second error amplifying threshold is higher than the first error amplifying threshold; and
when the error amplifying signal is higher than the second error amplifying threshold, the peak current threshold keeps at a second current threshold unchanged.

7. The control circuit of claim 1, further comprising:
a feedback sample-and-hold circuit coupled to the first pin to receive the auxiliary sampling signal and configured to generate the feedback voltage signal based on the auxiliary sampling signal.

8. The control circuit of claim 1, wherein the primary switch control circuit comprises:
a clock generator configured to generate a clock signal to control a switching frequency of the primary switch based on the error amplifying signal; wherein
when the error amplifying signal is between a first error amplifying threshold and a second error amplifying threshold, the switching frequency increases as the error amplifying signal increases, wherein the first error amplifying threshold is lower than the second error amplifying threshold;
when the error amplifying signal is between the second error amplifying threshold and a third error amplifying threshold, the switching frequency keeps at a first frequency unchanged; and
when the error amplifying signal is higher than the third error amplifying threshold, the switching frequency increases as the error amplifying signal increases.

9. The control circuit of claim 1, wherein after a duration when the auxiliary sampling signal remains below a wakeup voltage threshold reaches a wakeup duration threshold, if the auxiliary sampling signal becomes higher than the wakeup voltage threshold, the wakeup detecting signal is valid.

10. The control circuit of claim 9, wherein the wakeup detecting circuit comprises:
a wakeup comparing circuit configured to generate a wakeup comparing signal by comparing the auxiliary sampling signal with the wakeup voltage threshold;
a timer configured to generate a wakeup timing signal by timing the duration when the auxiliary sampling signal remains below the wakeup voltage threshold after the primary switch is turned off; and
a logic circuit configured to perform a logical operation on the wakeup comparing signal and the wakeup timing signal.

11. An isolated switching converter comprising:
a transformer having a primary winding and an auxiliary winding;
a primary switch coupled to the primary winding;
a wakeup detecting circuit configured to receive an auxiliary sampling signal indicative of a voltage across the auxiliary winding and to generate a wakeup detecting signal based on the auxiliary sampling signal;
an error amplifying circuit configured to generate an error amplifying signal based on a difference between a reference voltage signal and a feedback voltage signal indicative of an output voltage; and
a primary switch control circuit configured to generate a primary switch control signal to control the primary switch based on the wakeup detecting signal and the error amplifying signal; wherein
after a duration when the auxiliary sampling signal remains below a wakeup voltage threshold reaches a wakeup duration threshold, if the auxiliary sampling signal becomes higher than the wakeup voltage threshold, the wakeup detecting signal is valid.

12. The isolated switching converter of claim 11, further comprising:
a pull-up circuit configured to, in response to the wakeup detecting signal being valid, pull up the error amplifying signal when the error amplifying signal is lower than a first reference value.

13. The isolated switching converter of claim 12, wherein the pull-up circuit comprises:
a unidirectional conduction circuit having an input terminal and an output terminal, wherein the input terminal is configured to receive the first reference value; and
a switch having a first terminal, a second terminal and a control terminal, wherein the first terminal is coupled to the output terminal of the unidirectional conduction circuit, the second terminal is coupled to an output terminal of the error amplifying circuit and the control terminal is configured to receive the wakeup detecting signal.

14. The isolated switching converter of claim 11, wherein the primary switch control circuit is configured to turn on the primary switch in response to the wakeup detecting signal being valid.

15. The isolated switching converter of claim 11, wherein the primary switch control circuit comprises:
a current threshold generator configured to generate a peak current threshold based on the error amplifying signal and the wakeup detecting signal; and
a current comparing circuit configured to generate a turning off control signal by comparing a current sampling signal indicative of a current flowing through the primary switch with the peak current threshold; wherein
in response to the wakeup detecting signal being valid, the peak current threshold is configured to be set to an upper limit value.

16. A control circuit for an isolated switching converter, the control circuit comprising:
a secondary control circuit comprising:
a first pin configured to be coupled to a secondary winding of a transformer;
a second pin configured to receive an output voltage;
a load rise detecting circuit coupled to the second pin and configured to detect whether a load rise has occurred based on the output voltage; and
a wakeup processing circuit coupled to the first pin, wherein in response to the detected load rise, the wakeup processing circuit is configured to pull down a voltage at the first pin; and
a primary control circuit comprising:
a third pin configured to be coupled to an auxiliary winding of the transformer to receive an auxiliary sampling signal indicative of a voltage across the auxiliary winding;
a wakeup detecting circuit coupled to the third pin and configured to generate a wakeup detecting signal based on the auxiliary sampling signal; and
a primary switch control circuit configured to generate a primary switch control signal to control a primary switch based on the wakeup detecting signal.

17. The control circuit of claim 16, wherein the load rise detecting circuit comprises:
an output sample-and-hold circuit configured to receive a first feedback voltage signal indicative of the output voltage and to sample and hold the first feedback voltage signal to generate an output sample-and-hold signal; and
a load comparing circuit configured to compare the first feedback voltage signal with a proportional voltage signal indicative of the output sample-and-hold signal.

18. The control circuit of claim 16, wherein the wakeup processing circuit comprises:
a pull-down switch coupled to the first pin and a secondary reference ground, wherein the pull-down switch is configured to be turned on in response to the detected load rise.

19. The control circuit of claim 16, wherein the primary switch control circuit is configured to turn on the primary switch in response to the wakeup detecting signal being valid.

20. The control circuit of claim 16, wherein the primary control circuit comprises:
an error amplifying circuit configured to generate an error amplifying signal based on a difference between a reference voltage signal and a second feedback voltage signal indicative of the output voltage; and
a pull-up circuit configured to, in response to the wakeup detecting signal being valid, pull up the error amplifying signal when the error amplifying signal is lower than a first reference value; wherein
the primary switch control circuit is further configured to receive the error amplifying signal and to generate the primary switch control signal based on the error amplifying signal and the wakeup detecting signal.
